(19) United States
(12) Patent Application Publication
(10) Pub. No.: US 2013/0083071 A1
(43) Pub. Date: Apr. 4, 2013

(54) IMAGE DISPLAY APPARATUS, IMAGE DISPLAY METHOD AND COMPUTER READABLE RECORDING MEDIUM

(71) Applicant: Yoshiaki NAKAMURA, Tokyo (JP)

(72) Inventor: Yoshiaki NAKAMURA, Tokyo (JP)

(73) Assignee: CASIO COMPUTER CO., LTD., Tokyo (JP)

(21) Appl. No.: 13/615,443

(22) Filed: Sep. 13, 2012

(30) Foreign Application Priority Data
Sep. 30, 2011 (JP) 2011-215937

(51) Int. Cl. G09G 5/38; G09G 5/40; G09G 5/34

(52) U.S. Cl. 345/636; 345/682; 345/685; 345/634

(57) ABSTRACT

Disclosed is an image display apparatus including a recording unit in which a plurality of images are recorded, an obtaining unit which obtains at least one displaying image from the recording unit, a display unit and a setting unit which sets at least one image display region in the display unit. The image display apparatus further includes a deciding unit which decides a position for arranging the displaying image in the image display region and a control unit which displays the relating information corresponding to the displaying image in a non-arranging region along a longer dimensional direction thereof.

### CROSS-REFERENCE TO RELATED APPLICATIONS

This application is based upon and claims the benefit of priority under 35 USC 119 of Japanese Patent Application No. 2011-215937 filed on Sep. 30, 2011, the entire disclosure of which, including the description, claims, drawings, and abstract, is incorporated herein by reference in its entirety.

### BACKGROUND OF THE INVENTION

1. Field of the Invention

The present invention relates to an image display apparatus, an image display method and a computer readable recording medium in which a program for the image display apparatus to realize image display is stored.

2. Description of Related Art

Conventionally, there is known an image display method to display a plurality of images such as thumbnail images by arranging them in predetermined lines and columns to be displayed in catalog format (for example, see JP 2006-229291).

There is also known an image display method to display file names along with thumbnail images displayed in catalog format. However, in order to confirm information other than the file names, display has to be switched to a display of each image every time a user wishes to confirm other information.

When thumbnail images are to be displayed in catalog format with various types of information being superimposed on each image similarly to when images are displayed one at a time, there is a problem that the text indicating various types of information becomes small and difficult to be seen because the display region of each thumbnail image is small.

### SUMMARY OF THE INVENTION

In view of the above problem, an object of the present invention is to provide an image display apparatus which can display various types of information corresponding to each image in a style that can be visually recognized easily when a plurality of images are displayed in one display region, an image display method thereof and a computer readable recording medium which stores a program realizing the image display.

According to a first aspect of the present invention, there is provided an image display apparatus including a recording unit in which a plurality of images are recorded, an obtaining unit which obtains at least one displaying image from the recording unit, a display unit which displays the displaying image, a setting unit which sets at least one image display region in the display unit wherein the displaying image and relating information corresponding to the displaying image are to be displayed in the image display region, a deciding unit which decides a position for arranging the displaying image in the image display region on the basis of a ratio of the numbers of pixels in two directions orthogonal to each other in the displaying image, and a control unit which displays the relating information corresponding to the displaying image in a non-arranging region along a longer dimensional direction thereof, the non-arranging region being a region where the displaying image is not arranged in the image display region in which the position for arranging the displaying image is decided by the deciding unit.

According to a second aspect of the present invention, there is provided an image display method utilizing an image display apparatus comprising a recording unit in which a plurality of images are recorded and a display unit, the method including obtaining at least one displaying image from the recording unit, setting at least one image display region in the display unit wherein the displaying image and relating information corresponding to the displaying image are to be displayed in the image display region, deciding a position for arranging the displaying image in the image display region on the basis of a ratio of the numbers of pixels in two directions orthogonal to each other in the displaying image, and displaying the relating information corresponding to the displaying image in a non-arranging region along a longer dimensional direction thereof, the non-arranging region being a region where the displaying image is not arranged in the image display region in which the position for arranging the displaying image is decided by the deciding unit.

According to a third aspect of the present invention, there is provided a computer readable recording medium in which a program for making a computer of an image display apparatus function as an obtaining unit which obtains at least one displaying image from the recording unit, a setting unit which sets at least one image display region in the display unit wherein the displaying image and relating information corresponding to the displaying image are to be displayed in the image display region, a deciding unit which decides a position for arranging the displaying image in the image display region on the basis of a ratio of the numbers of pixels in two directions orthogonal to each other in the displaying image, and a control unit which displays the relating information corresponding to the displaying image in a non-arranging region along a longer dimensional direction thereof, the non-arranging region being a region where the displaying image is not arranged in the image display region in which the position for arranging the displaying image is decided by the deciding unit, wherein the computer of the image display apparatus comprises a recording unit in which a plurality of images are recorded and a display unit.

According to the present invention, when a plurality of images are displayed in one display region, various types of information corresponding to each image can be displayed in a style that can be visually recognized easily.

### BRIEF DESCRIPTION OF THE DRAWINGS

The above and other objects, advantages are features of the present invention will become more fully understood from the detailed description given hereinbelow and the appended drawings which are given by way of illustration only, and thus are not intended as a definition of the limits of the present invention, and wherein:

FIG. 1 is a block diagram showing a schematic configuration of an image display apparatus of the embodiment in which the present invention is applied;

FIG. 2 is a flowchart showing an example of operation relating to preset processing performed in the image display apparatus of FIG. 1;

FIG. 3 is a flowchart showing an example of operation relating to image display processing performed in the image display apparatus of FIG. 1;

FIG. 4 is a diagram showing an example of images in relation to the image display processing of FIG. 3;

FIG. 5A is a diagram showing a part of the images shown in FIG. 4;

FIG. 5B is a diagram showing a part of the images shown in FIG. 4; and

FIG. 5C is a diagram showing a part of the images shown in FIG. 4.

### DESCRIPTION OF THE PREFERRED EMBODIMENT

Hereinafter, a particular embodiment of the present invention will be described with reference to the drawings. However, the scope of the invention is not limited to the examples shown in the drawings.

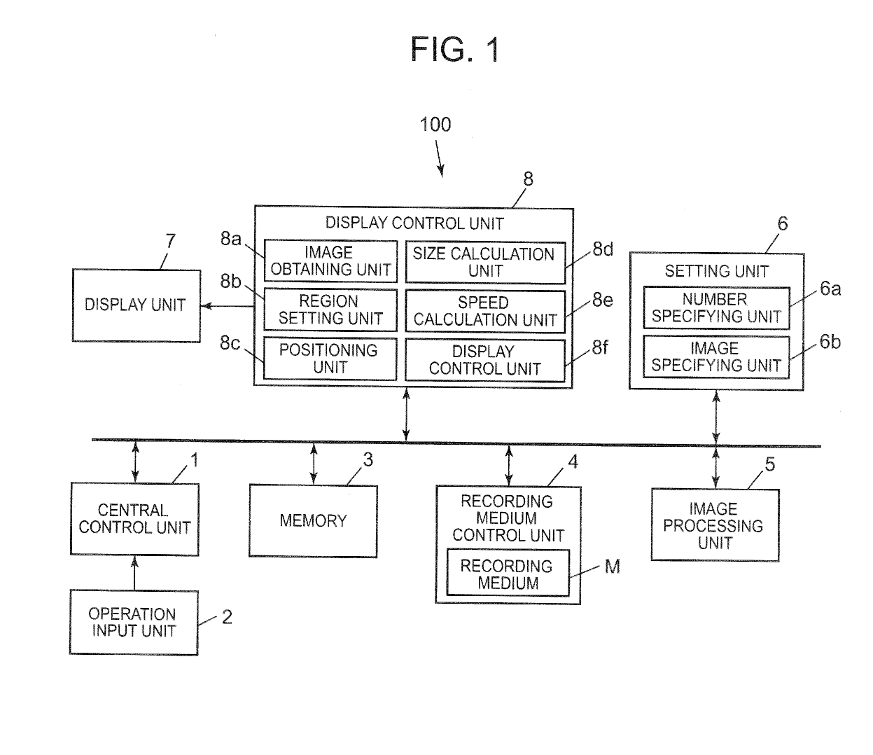

FIG. 1 is a block diagram showing a schematic configuration of the image display apparatus 100 of the embodiment in which the present invention is utilized.

In the image display apparatus 100 of the embodiment, the position where an image is to be arranged is decided at least on the basis of either of the setting direction of the image pickup device when the image was picked up (vertically photographing or horizontally photographing) and the ratio of the numbers of pixels in two directions which are orthogonal to each other in the image in each of a plurality of image display regions when a plurality of images are to be displayed so that each of the plurality of image display regions have one corresponding image displayed therein. Further, in the image display apparatus 100, relating information corresponding to the image is displayed in the non-arranging region in each of the plurality of image display regions along the longer dimensional direction thereof, the non-arranging region in each of the plurality of image display regions being a region where the image is not arranged in the image display region in which the position for arranging the image is decided.

In particular, the image display apparatus 100 is a digital photo frame which is to be set on a table, for example. As shown in FIG. 1, the image display apparatus 100 includes a central control unit 1, an operation input unit 2, a memory 3, a recording medium control unit 4, an image processing unit 5, a setting unit 6, a display unit 7 and a display control unit 8.

The central control unit 1 controls each part of the image display apparatus 100. In particular, although not shown in the drawing, the central control unit 1 includes a CPU (Central Processing Unit), a RAM (Random Access Memory) and a ROM (Read Only Memory), and the central control unit 1 executes various types of control operations according to various types of processing programs (omitted in the drawing) for the image display apparatus 100.

The operation input unit 2 includes an operation unit (omitted in the drawing) which is operated by a user, and the operation input unit 2 outputs predetermined signals according to the predetermined operations to the central control unit 1.

For example, the operation unit is configured by including data input keys for inputting numeral values and texts, up, down, left and right moving keys for carrying out operations such as selection and forwarding operation and function keys for giving instructions to execute various types of functions.

The operation input unit 2 includes a touch panel (omitted in the drawing) which is provided integrally with the display panel of the display unit 7. Operations such as inputting of numerical values and text, data selection and forwarding operation can be carried out according to predetermined operations performed by a user on the touch panel.

For example, the memory 3 includes a DRAM (Dynamic Random Access Memory) and the like, and is provided with a buffer memory in which various types of data are temporarily stored, a working memory which becomes a working region for the CPU of the central control unit 1, a program memory where various types of programs and data according to the functions of the image display apparatus 100 are stored and the like (all of them are omitted in the drawing).

The recording medium control unit 4 is configured in a way the recording medium (recording device) M is detachable, and the recording medium control unit 4 controls reading of data from the inserted recording medium M and writing of data to the recording medium M.

That is, the recoding medium control unit 4 reads out image data of still images encoded according to a predetermined encoding system (for example, JPEG format, Motion JPEG format, MPEG format, etc.) and image data of moving image consisting of number of frame images from a recording medium M and sends the read image data to the image processing unit 5.

The recording medium M includes a non-volatile memory (flash memory), for example. However, the recording medium M is not limited to such example and can be arbitrarily modified.

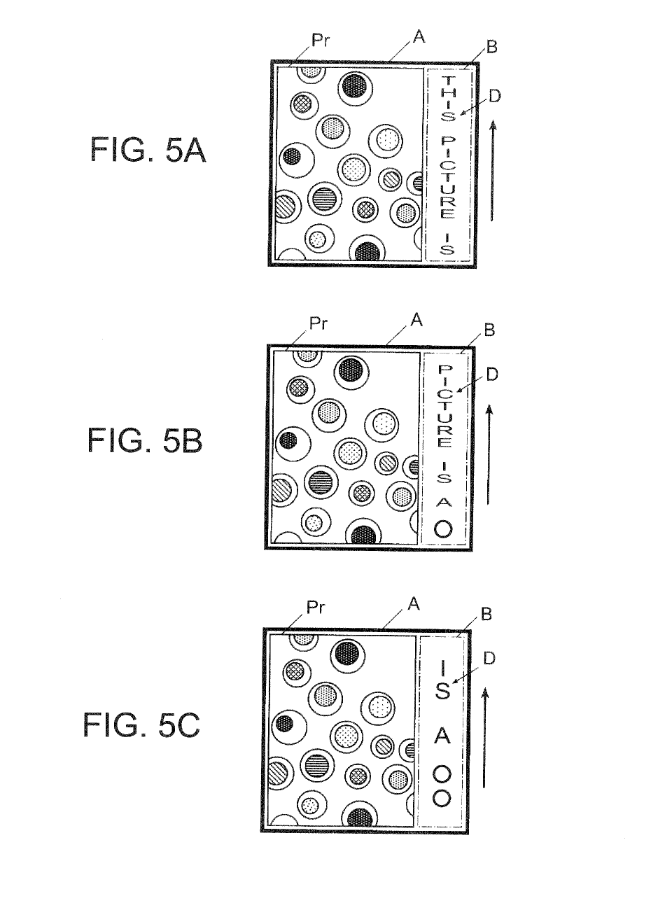

Image data of still images includes an image file of Exif (Exchangeable Image File Format) format, for example, and relating information D (see FIG. 5A) corresponding to the still image is associated with the real data of the still image as tag information.

As for relating information D, image pickup data information relating to the date when the image was picked up, setting direction (for example, vertically photographing, horizontally photographing, etc.) of the image pickup device with which the image was picked up, ISO speed, white balance, image pickup condition information relating to the focus method and the like, mode information relating to the image pickup mode at the time when the image was picked up, pickup position information relating to the position where the image was picked up, image processing information relating to image processing content such as subject cut-out processing and art conversion processing performed on the image and comment information relating to a comment input after the image was picked up are suggested, for example.

Here, relating information D is not limited to the above exemplified various types of information and can be arbitrarily modified.

The subject cut-out processing is a process to cut out the area where the subject exists from the image in which the subject is included in a predetermined background. Detail description of the subject cut-out processing will be omitted here due to the processing being a known technique.

The art conversion processing is a process to change the visual effect of a predetermined image, that is, to change the display style of the image displayed in the display unit 7.

As for art conversion processing, “pastel effect” in which the image is processed so as to have visual effect as if drawn with pastel pencils, “silk screen effect” in which the image is processed so as to have visual effect as if it is printed on silk screen and “oil paint effect” in which the image is processes so as to have visual effect as if it is oil painted are suggested, for example. However, the art conversion processing is not limited to the above examples and can be arbitrarily modified.

Techniques for processing an image to have various types of visual effects are realized by processes similar to the processing using software of known image processing, and are realized by changing color tone, chroma, brightness and the like in HSV color space and using various types of filters. Due to such techniques being known techniques, the detail description is omitted. Here, “XX effect” corresponds to a visual effect realized by performing art conversion processing which can be realized by using software related to the known image processing.

Similarly to the still images, relating information corresponding to the image is associated with the real data of a moving image in the image data of moving image. Moreover, image data of moving image may include any one of frame images that forms the moving image as the representing image.

The image processing unit 5 decodes the image data of still images or moving images which are subjected to be displayed read out from the recording medium M by the recording medium control unit 4 according to the corresponding predetermined encoding system (for example, JPEG format, motion JPEG format, MPEG format etc.) and outputs the decoded image data to the display control unit 8. At this time, the image processing unit 5 may reduce the image data read out from the recording medium M to a predetermined size (for example, VGA size) on the basis of display resolution or the like of the display unit 7 and output the reduced image data to the display control unit 8.

The setting unit 6 performs the preset processing (after-mentioned) to set various types of information relating to image display processing (after-mentioned). In particular, the setting unit 6 includes a number specifying unit 6a and an image specifying unit 6b.

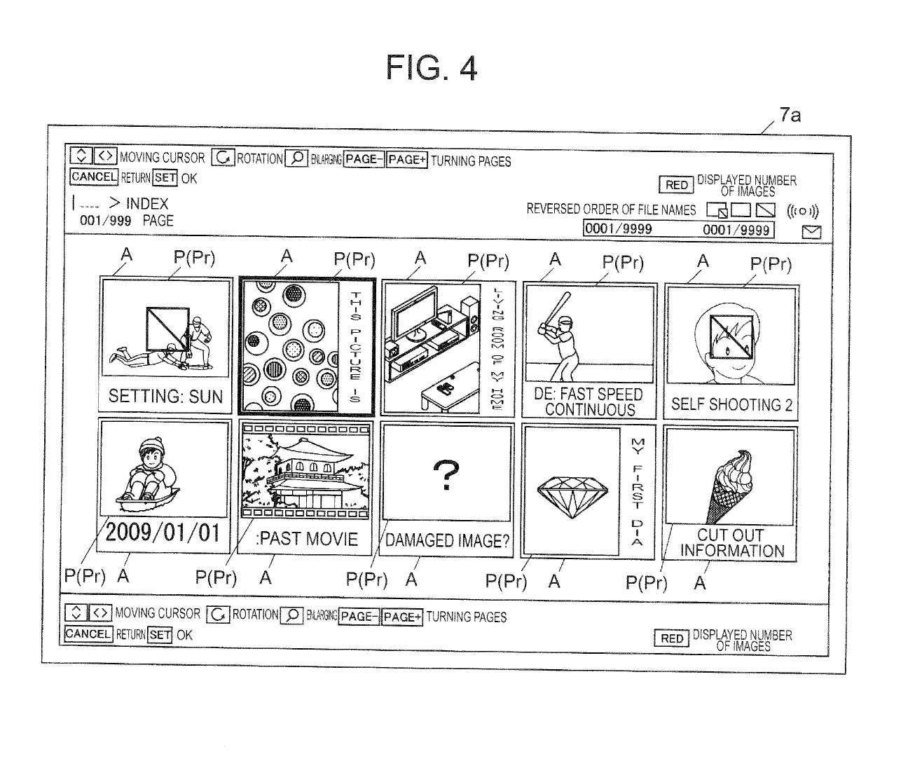

The number specifying unit 6a specifies the number of reduced images Pr (see FIG. 4) to be display in the display screen (display region) 7a (see FIG. 4) of the display unit 7 at one time.

That is, the number specifying unit 6a specifies the number of reduced images Pr to be displayed in the display screen 7a in catalog format on the basis of a predetermined operation performed by a user on the operation input unit 2. In particular, when an instruction regarding specifying of the number of images desired by a user is output from the operation input unit 2 on the basis of a predetermined operation performed by a user and is input to the CPU of the central control unit 1, the CPU outputs the instruction regarding specifying of the number of images desired by a user to the number specifying unit 6a. The number specifying unit Ga specifies the number of images desired by a user as the number of reduced images Pr to be displayed in the display screen 7a at one time on the basis of the instruction which is output from the CPU of the central control unit 1 and input to the number specifying unit 6a.

For example, the number specifying unit 6a may automatically specify the number of reduced images Pr which is set as default or the number of reduced images Pr which is previously set.

Here, the number specifying unit 6a constitutes the first specifying device which specifies the number of reduced images Pr to be displayed in the display screen 7a at one time.

The image specifying unit 6b specifies a plurality of images P (see FIG. 4) which are subjected to be displayed.

That is, the image specifying unit 6b specifies a plurality of images P corresponding to the reduced images Pr to be displayed in the display screen 7a on the basis of a predetermined operation performed by a user on the operation input unit 2. In particular, when an instruction regarding specifying of a plurality of images P desired by a user is output from the operation input unit 2 on the basis of the predetermined operation performed by a user and the instruction is input to the CPU of the central control unit 1, the CPU outputs the instruction regarding specifying of a plurality of images P desired by a user to the image specifying unit 6b.

The specifying operation of a plurality of images P based on the predetermined operation performed by a user on the operation input unit 2 may be carried out by specifying one folder in which a plurality of image files are stored or may be carried out by specifying the images P desired by a user one by one, for example.

The image specifying unit 6b specifies the images P corresponding to the plurality of reduced images Pr to be displayed in the display screen 7a in catalog format on the basis of the instruction which is output from the CPU of the central control unit 1 and input to the image specifying unit 6b.

For example, the image specifying unit 6b may automatically specify the plurality of images P which are set as default or the plurality of images P which are previously specified.

Here, the image specifying unit 6b constitutes the second specifying device which specifies a plurality of images P (reduced images Pr) to be displayed in the display screen 7a.

The display unit 7 includes a liquid crystal panel or an Organic Electro-Luminescence display panel, for example. The display unit 7 displays the predetermined images stored in the recording medium M in the display screen 7a under the control of the display control unit 8.

The display control unit 8 controls so as to display the predetermined images, various types of information and the like in the display unit 7.

That is, by outputting image data of images which are subjected to be displayed, the display control unit 8 controls so as to display the image data in the display screen 7a of the display unit 7. In particular, the display control unit 8 makes the display screen (display region) 7a of the display unit 7 display the plurality of reduced images pr which are subjected to be displayed in catalog format.

Here, catalog format is a format where a user can visually recognize a plurality of reduced images Pr at once. For example, such format where a plurality of reduced images Pr are arranged in predetermined lines and columns having predetermined spaces therebetween (for example, equally spaced from each other) is suggested as catalog format. The way of displaying a plurality of reduced images Pr in a catalog format as shown in FIG. 4 is an example and displaying style is not limited to this example. The displaying style can be arbitrarily modified as long as a user can visually recognize the plurality of reduced images Pr at once.

The display control unit 8 includes an image obtaining unit 8a, a region setting unit 8b, a positioning unit 8c, a size calculation unit 8d, a speed calculation unit Se and a display control unit 8f.

The image obtaining unit 8a obtains images P which are subjected to be displayed.

That is, the image obtaining unit 8a obtains image data of the plurality of images P which are specified by the image specifying unit 6b on the basis of the predetermine operation performed by a user on the operation input unit 2 among the images stored in the recording medium M as images P which are subjected to be displayed. In particular, by the images being specified by the image specifying unit 6b on the basis of the predetermined operation performed by a user on the operation input unit 2, the image obtaining unit 8a obtains image data of the plurality of images P in a predetermined size, the plurality of images P being read out from the recording medium M by the recording medium control unit 4 and decoded by the image processing unit 5.

Here, the image obtaining unit 8a constitutes the obtaining device which obtains a plurality of images P which are stored in the recording medium M.

The region setting unit 8b sets a plurality of image display regions A (see FIG. 4) in the display screen 7a of the display unit 7.

That is, according to the number of reduced images Pr to be displayed at one time specified by the number specifying unit 6a on the basis of the predetermined operation performed by a user on the operation input unit 2, the region setting unit 8b sets a predetermined number of image display regions A in the display screen 7a, in each of which a reduced image Pr is to be displayed individually. In particular, according to the number of reduced images Pr (for example, ten reduced images) to be displayed at one time specified by the number specifying unit 6a, the region setting unit 8b decides the arrangement style of the reduced images Pr (for example, 5 columns in 2 rows; see FIG. 4). Then, the region setting unit 8b calculates the number of pixels to be set in one side of each approximately square shaped image display region A that can be displayed in the arrangement of the reduced images Pr on the basis of the display resolution (the numbers of pixels in vertical direction and horizontal direction) of the display screen 7a. Then, the region setting unit 8b virtually sets a plurality of image display regions A in the calculated size (the number of pixels in one side) in the display screen 7a.

Vertical direction and horizontal direction in the display screen 7a and the image display regions A correspond to the directions approximately parallel with up-down direction and right-left direction, respectively, when the image display apparatus 100 is disposed so that the display screen 7a is wide in horizontal direction as shown in FIG. 4.

The above shape of the image display regions A is only an example and the shape is not limited to such shape. The shape can be arbitrarily modified.

In such way, the region setting unit 8b constitutes the setting means which sets a plurality of image display regions A, in each of which a reduced image Pr is to be individually displayed, in the display screen 7a.

The positioning unit 8c decides the positions where the reduced images Pr are to be arranged in the image display regions A, the reduced images Pr respectively corresponding to the plurality of images P obtained by the image obtaining unit 8a.

That is, in each of the plurality of image display regions A, the positioning unit 8c decides the position where a reduced image Pr is to be arranged at least on the basis of either of the setting direction of the image pickup device when the image P was picked up and the ratio of the numbers of pixels in two directions orthogonal to each other in the image P. In particular, with respect to the reduced image Pr displayed in each of the image display regions A, the positioning unit 8c obtains the setting direction (for example, vertically photographing, horizontally photographing) of the image pickup device which picked up the image P which is an original image of the reduced image Pr and the ratio of the numbers of pixels in vertical and horizontal directions in the image P (aspect ratio; for example, 4:3, 3:2 and 16:9). The positioning unit 8c reduces the image data of the image P in its vertical direction and horizontal direction to a predetermined ratio on the basis of the obtained ratio of the numbers of pixels in vertical and horizontal directions of the image P and the number of pixels in vertical direction and horizontal direction of the image display region A, and then, generates image data of the reduced image Pr in a size displayable in the image display region A. Here, it is preferred that the size of the reduced image Pr is the maximum size the reduced image Pr can be displayed in the image display region A.

The positioning unit 8c decides the positions where the reduced images Pr are to be arranged in the image display regions A on the basis of the obtained setting direction of the image pickup device when each image P was picked up. In particular, in each of the image display regions A, the positioning unit 8c decides the position where the reduced image Pr of the image P is to be arranged so that the reduced image Pr is arranged against one side that is orthogonal (for example, horizontal direction) to the setting direction (for example, “vertical photographing”) of the image pickup device when the image P was picked up. For example, when the setting direction of the image pickup device when the image P was picked up is “vertical photographing”, the positioning unit 8c decides the position where the reduced image Pr is to be arranged so as to be against either of the sides in horizontal direction (for example, left side in FIG. 4) in the image display region A (see FIG. 4) Further, for example, when the setting direction of the image pickup device when the image P was picked up is “horizontal photographing”, the positioning unit 8c decides the position where the reduced image Pr to be arranged so as to be against either of the sides in vertical direction (for example, upper side in FIG. 4) in the image display region A.

Here, similarly as in the display screen 7a and in the image display region A, vertical direction and horizontal direction in an image P correspond to directions approximately parallel with up-down direction and left-right direction, respectively, when the image display apparatus 100 is disposed so that the display screen 7a thereof is arranged as shown in FIG. 4, for example.

In such way, the positioning unit 8c constitutes the deciding device which decides the positions where the images P (reduced images Pr) are to be arranged in the plurality of image display regions A, respectively, at least on the basis of either of the setting direction of the image pickup device when each of the images P was picked up and the ratio of the numbers of pixels in two directions orthogonal to each other in each of the images P.

The size calculation unit 8d calculates the display size of relating information D in each of the plurality of image display regions A.

That is, the size calculation unit 8d calculates the display size of the relating information D to be displayed in the non-arranging region B on the basis of the number of pixels in the shorter dimensional direction of the non-arranging region B which is orthogonal to the longer dimensional direction thereof (see FIG. 5A) in each of the image display region A, wherein the non-arranging region B is a region in which the reduced image Pr is not arranged. In particular, in each of the image display regions A, the size calculation unit 8d specifies the approximately rectangular non-arranging region B adjacent to the reduced image Pr displayed in the image display region A and calculates the number pixels in the shorter dimensional direction (for example, horizontal direction in FIG. 5A) of the non-arranging region B. Then, the size calculation unit 8d calculates the display size (font size of the letters) of the letter string of the relating information D, for example, picked up date, image pickup condition, image pickup mode, picked up position, content and the like, corresponding to the reduced image Pr to be arranged in the non-arranging region B.

That is, the size (area) of the non-arranging region B and the display size of relating information D are to be different according to the ratio of the numbers of pixels in vertical direction and horizontal direction of the reduced image Pr (image P) displayed in each image display region A. For example, when the aspect ratio is 4:3, font size of the letters is “8”, when the aspect ratio is 3:2, font size of the letters is “10.5” and when the aspect ratio is 16:9, font size of the letters is “10”.

In such way, the size calculation unit 8d constitutes the first calculation device which calculates the display size of the relating information D to be displayed in the non-arranging region B on the basis of the number of pixels in the shorter dimensional direction of the non-arranging region B of the image display region A orthogonal to the longer dimensional direction thereof.

The speed calculation unit 8e calculates the speed for scroll displaying the letter string of relating information D.

That is, on the basis of the number of letters in the letter string expressing the content of the relating information D, the speed calculation unit 8e calculates the speed for scroll displaying the letter string. In particular, for example, when letter string regarding picked up date, image pickup condition, image pickup mode, picked up position, content of image processing, comment and such like is set as the display content of the relating information D, the speed calculation unit 8e obtains the number of letters in the litter string and compares the obtained number of letters to a predetermined threshold to make a judgment. According to the judgment result, the speed calculation unit 8e calculates the speed for scroll displaying the letter string, that is, the speed calculation unit 8e calculates the distance one letter in the letter string moves in a predetermined direction per unit time, the distance being represented by the number of pixels.

For example, when the number of letters in the letter string is greater than the predetermined threshold, the speed calculation unit 8e calculates the speed for scroll displaying the letter string so as to be relatively faster comparing to the reference speed. On the other hand, when the number of letters in the letter string is equal to or smaller than the predetermined threshold, the speed calculation unit 8e calculates the speed for scroll displaying the letter string so as to be relatively slower comparing to the reference speed.

Here, scroll displaying refers to displaying all of the letters constituting a predetermined letter string by moving the letter string in a predetermined direction in units of a predetermined number of letters (for example, 5 letters) (see FIGS. 5A to 5C). At this time, scroll displaying may be a display where all of the letters are repeated in cycles or may be a display where the display is stopped at a predetermined place after all of the litters are displayed.

As described above, the speed calculation unit 8e constitutes the second calculation means which calculates the speed for scroll displaying the letter string on the basis of the number of letters in the letter string of the relating information D.

The display control unit 8f displays the relating information D in the non-arranging regions B in the image display regions A along the longitudinal direction thereof.

That is, in each of the image display regions A in which the position for arranging the corresponding reduced image Pr is decided by the positioning unit 8c, the display control unit 8f displays the relating information D relating to the reduced image Pr in the rectangular non-arranging region B along its longer dimensional direction. In particular, the display control unit 8f scroll displays the relating information D in the non-arranging region B in the image display region A along the longer dimensional direction thereof wherein the image display region A being the region for displaying one reduced image Pr which is selected on the basis of a predetermined operation performed by a user on the operation input unit 2 among the reduced images Pr displayed respectively in the image display regions A.

At this time, the display control unit 8f may display the letter string of the relating information D in the non-arranging region B in the display size calculated by the calculation unit 8d (for example, font size of 8). Further, the display control unit 8f may scroll display the letter string at the speed calculated by the speed calculation unit 8e (for example, slow).

Here, it is preferred that the direction of the letter string of the relating information D is in vertical writing when the letter string is scrolled in vertical direction and is in horizontal writing when the letter string is scrolled in horizontal direction. However, when relating information D formed of date information and image pickup condition in numbers and alphabets is to be scroll displayed in vertical direction, the information may be in horizontal writing for easy reading.

In such way, the display control unit 8f constitutes the control device which displays the relating information D corresponding to the reduced image Pr in the non-arranging region B where the reduced image Pr is not arranged along the longer dimensional direction thereof in each of the image display regions A in which the positions for arranging the reduced images Pr are decided by the positioning unit 8c.

Further, the display control unit 8f may display the relating information D in the display style corresponding to the content of image processing on the basis of the image processing information included in the relating information D.

That is, when art conversion processing is performed as image processing on an original image of the reduced image Pr displayed in an image display region A, for example, the display control unit 8f performs the processing which brings out a visual effect that allows a user associate with the art conversion processing (for example, “pastel effect”) on the letter string of the relating information D. In such way, the display control unit 8f displays the relating information D in the non-arranging region B in the display style corresponding to the art conversion processing (for example, “pastel effect”) In particular, the display control unit 8f displays the letter string of the relating information D in the font (for example, “rounded handwriting”) and color (for example, “pastel color”) corresponding to the content of the art conversion processing (for example, “pastel effect”) as the image processing, for example.

Similarly, the display control unit 8f may display the background region of the relating information D in the non-arranging region B in the display style corresponding to the content of the image processing on the basis of the image processing information included in the relating information D.

That is, in a similar way as described above, for example, when art conversion processing is performed on the original image of the reduced image Pr displayed in an image display region A as image processing, the display control unit 8f performs the processing which brings out the visual effect that allows a user to associate with the same art conversion processing (for example, “pastel effect”) on the background region of the relating information D in the non-arranging region B.

In particular, for example, the display control unit 8f specifies the color corresponding to the content of the art conversion processing (for example, “pastel effect”) as image processing as the background color of the non-arranging region B and displays the background in the specified color. Further, for example, the display control unit 8f obtains the image corresponding to the content of the art conversion processing (for example, “pastel effect”) as image processing, which is the image on which the same art conversion processing is performed, for example, and displays the obtained image in the background region of the non-arranging region B.

In addition to background region in the non-arranging region B, the display control unit 8f may display the background portion of the reduced image Pr in the image display region A, that is, the there edge sections around the reduced image Pr in the image display region A other than the non-arranging region B in the display style corresponding to the content of image processing.

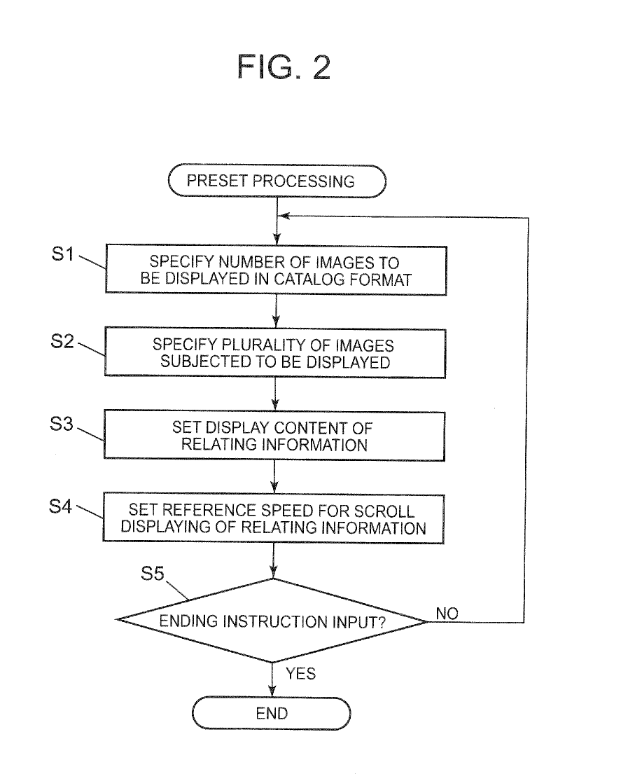

Next, the preset processing of the image display apparatus 100 will be described with reference to FIG. 2.

FIG. 2 is a flowchart showing an example of operation regarding the preset processing.

The following preset processing is a process to set various types of information regarding image display processing and is to be performed at a predetermined timing before the image display processing. That is, the preset processing is executed when the preset processing mode is selected and instructed among a plurality of operation modes on the basis of a predetermined operation of up, down, left and right moving keys and various types of function keys performed by a user on the operation input unit 2.

As shown in FIG. 2, first, the number specifying unit 6a of the setting unit 6 specifies the number of images P (reduced images Pr) to be displayed in the display screen 7a of the display unit 7 in catalog format (step S1).

In particular, when the number of images desired by a user is indicated on the basis of a predetermined operation performed by a user on the operation input unit 2, the operation input unit 2 outputs the indication to the CPU of the central control unit 1. The CPU outputs the indication regarding the specifying of the number of images desired by a user to the number specifying unit Ga, and the number specifying unit 6a specifies the number of images desired by a user as the number of reduced images Pr to be displayed in the display screen 7a of the display unit 7 in catalog format.

Next, the image specifying unit 6b of the setting unit 6 specifies the plurality of images P which are subjected to be displayed (step S2).

In particular, when the plurality of images P desired by a user are indicated on the basis of a predetermined operation performed by a user on the operation input unit 2, the operation input unit 2 outputs the indication to the CPU of the central control unit 1. The CPU outputs the indication regarding the specifying of the plurality of images P desired by a user to the image specifying unit 6b, and then, the image specifying unit 6b specifies the plurality of images P corresponding to the plurality of reduced images Pr to be displayed in the display screen 7a.

Next, the setting unit 6 sets the display content to be displayed as relating information D corresponding to each image P (reduced image Pr) on the basis of a predetermined operation performed by user on the operation input unit 2 (step S3).

Here, the display content of relating information D may be set for each reduced image Pr or may be commonly set for all of the plurality of reduced images Pr to be displayed in a catalog format, f or example.

Next, the setting unit 6 sets the reference speed for scroll displaying the relating information D by the display control unit 8f on the basis of a predetermined operation performed by a user on the operation input unit 2 (step S4). In particular, the setting unit 6 sets any one speed selected by a user among “fast”, “normal”, “slow” and the like as a reference speed, for example.

Here, “fast” is relatively faster comparing to “normal” and “slow” is relatively slower comparing to “normal”.

Next, the CPU of the central control unit 1 determines whether an instruction to end the preset processing is input on the basis of a predetermined operation performed by a user on the operation input unit 2 (step S5).

When it is determined that the ending instruction is not input (step S5; NO), the setting unit 6 returns the processing to step S1 and sequentially executes the processing thereafter.

On the other hand, when it is determined that the ending instruction is input in step S5 (step S5; YES), the CPU of the central control unit 1 ends the preset processing of the setting unit 6.

Here, the execution order of setting processing of the number of reduced images Pr (step S1), setting processing of a plurality of images P (step S2), setting processing of display content of relating information D (step S3) and setting processing of reference speed for scroll displaying (step S4) in the above preset processing is only an example and the order is not limited to this order. The execution order of the above processing can be changed arbitrarily.

Further, the configuration may be such that the preset processing is ended after the setting processing of reference speed for scroll displaying in step S4 is completed and then the image display processing is executed automatically.

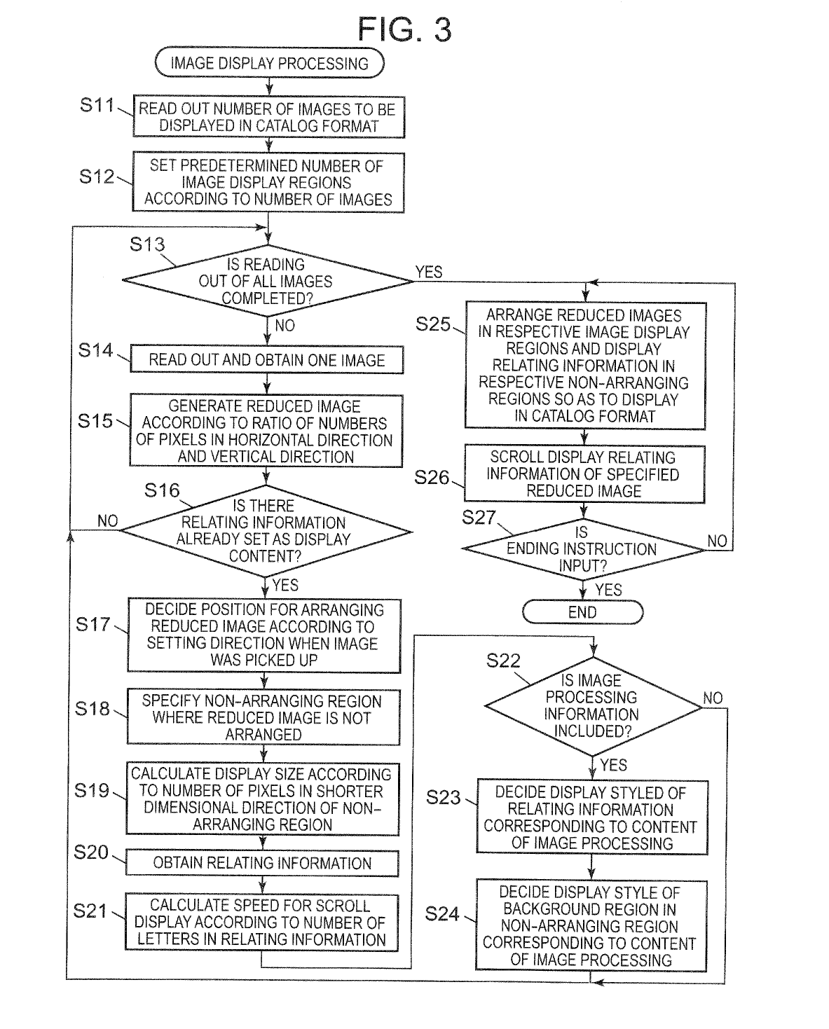

Next, the image display processing of the image display apparatus 100 will be described with reference to FIGS. 3 to 4 and FIGS. 5A to 5C.

FIG. 3 is a flowchart showing an example of operation regarding image display processing. Further, FIG. 4 is a diagram showing an example of reduced images Pr with regard to the image display processing. FIGS. 5A to 5C are enlarged diagrams of a reduced image Pr in FIG. 4, and scroll displaying is performed in the order of the state shown in FIG. 5A, the state shown in FIG. 5B and the state shown in FIG. 5C.

The following image display processing is executed when the image display mode is selected and instructed among a plurality of operation modes on the basis of a predetermined operation of up, down, left and right moving keys or various types of function keys performed by a user on the operation input unit 2.

As shown in FIG. 3, first, the region setting unit 8b of the display control unit 8 reads out and obtains the number of reduced images Pr (for example, ten reduced images) to be displayed in catalog format specified by the number specifying unit 6a of the setting unit 6 (step S11).

Next, the region setting unit 8b decides the arranging style of the reduced images Pr according to the number of reduced images Pr to be displayed in catalog format (for example, 5 columns in 2 rows; see FIG. 4), and thereafter, the region setting unit 8b sets approximately square shape image display regions A corresponding to the reduced image Pr in the display screen 7a (step S12). In particular, the region setting unit 8b calculates the number of pixels to be set in one side of each approximately square shape image display region A that can be displayed when arranging the reduced images Pr on the basis of display resolution of the display screen 7a and virtually sets a plurality of display regions A each of which having the calculated number of pixels set as the number of pixels in one side thereof in the display screen 7a.

Next, the image obtaining unit 8a determines whether reading out of all of the images P, which are specified by the image specifying unit 6b of the setting unit 6, from the recording medium M by the recording medium control unit 4 is completed (step S13).

When it is determined that the reading of all of the images P is not competed in step S13 (step S13; NO), the recording medium control unit 4 reads out image data of any one of images P which is not yet read out from the recording medium M and the image obtaining unit 8a obtains the image data of the image P, which is read out from the recording medium N and decoded by the image processing unit 5, in a predetermined size (step s14).

Next, the positioning unit 8c obtains the ratio (aspect ratio) of the number of pixels in vertical direction and the number of pixels in horizontal direction in the image P obtained by the image obtaining unit 8a and reduces the image data of the image P by the predetermined ratio in its vertical direction and horizontal direction to generate image data of a reduced image Pr in a size displayable in the image display region A on the basis of the ratio of the numbers of pixels in vertical direction and horizontal direction of the image P and the numbers of pixels in vertical direction and horizontal direction in the image display region A (step S15).

Next, the positioning unit 8c determines whether relating information D which is already set as the display content by the setting unit 6 is included in various types of relating information D corresponding to the image P which is subjected to processing as tag information (step S16).

When it is determined that there is no relating information D already set as the display content (step S16; NO), the display control unit 8 returns the processing to step S13 and sequentially executed the processing thereafter.

On the other hand, when it is determined that relating information D already set as the display content is included (step S16; YES), the positioning unit 8c obtains the setting direction of the image pickup device when the image P which is subjected to processing was picked up and decides the position where the reduced image Pr is to be arranged in an image display region A on the basis of the setting direction of the image pickup device when the image was picked up (step S17).

Next, the size calculation unit 8d specifies the approximately rectangular non-arranging region B, where the reduced image Pr is not arranged, adjacent to the reduced image Pr arranged in each image display region A (step S18). Then, after calculating the number of pixels in the shorter dimensional direction of the specified non-arranging region B, the size calculating unit 8d calculates the display size of the relating information D to be arranged in the non-arranging region B, that is, the display size of the letter string of the relating information D (for example, comment) which is already set as the display content (step S19).

Next, after the display control unit 8 obtains the relating information D corresponding to the image P which is subjected to processing as tag information and which is already set as the display content (step S20), the speed calculation unit 8e calculates the speed for scroll displaying the letter string on the basis of the number of letters in the letter string of the relating information D (step S21). In particular, the speed calculating unit 8e calculates the speed for scroll displaying the letter string by referring to the reference speed for scroll displaying which is already set by the setting unit 6 on the basis of the result of comparison between the number of letters in the letter string and the predetermined threshold.

Thereafter, the display control unit 8f determines whether image processing information regarding the content of various types of image processing is included in the relating information D which is already set as the display content (step S22).

When it is determined that the image processing information is not included in step S22 (step S22; NO), the display control unit 8 returns the processing to step S13 and sequentially executes the processing thereafter.

On the other hand, when it is determined that the image processing information is included in step S22 (step S22; YES), the display control unit 8f decides the display style of the relating information D corresponding to the content of image processing (step S23). In particular, the display control unit 8f decides the visual effect which allows a user to associate with the image processing (for example, art conversion processing) performed on the image P which is subject to the processing as the display style of the letter string of the relating information D (for example, font type and color of the letters).

Next, the display control unit 8f decides the display style of the background region of the relating information D in the non-arranging region B corresponding to the content of image processing (step S24). In particular, the display control unit 8f decides the visual effect which allows a user to associate with the image processing performed on the image P which is subjected to the processing as the display style of the background region of the relating information D in the non-arranging region B (for example, color and background image).

Thereafter, the display control unit 8 returns the processing to step S13 and sequentially executes the processing thereafter.

When it is determined that reading out of all of the images P is completed in step S13 (step S13; YES), the display control unit 8f displays the plurality of reduced images Pr and their relating information D in the display screen 7a in the display unit 7 in catalog format (step S25; FIG. 4). In particular, in each of the image display regions A, the display control unit 8f arranges the reduced image Pr at the predetermined position and arranges the relating information D in the approximate rectangular non-arranging region B along the longer dimensional direction.

At this time, the display control unit 8f displays the letter string of the relating information D in the non-arranging region B in the display size which is calculated by the size calculation unit 8d in step S19. Further, the display control unit 8f performs processing which brings out the visual effect that allows a user to associate with the same image processing performed on the reduced image Pr on the letter string of the relating information D and displays the letter string in the non-arranging region B so that the relating information D will be displayed in the style decided in step S23. Furthermore, the display control unit 8f performs processing which brings out the visual effect that allows a user to associate with the same image processing performed on the reduced image Pr on the background region and displays the background region in the non-arranging region B so that the background region of the relating information D will be displayed in the non-arranging region B in the style decided in step S24.

Thereafter, the display control unit 8f scroll displays the letter string of the relating information D corresponding to the reduced image Pr which is specified by a user in the non-arranging region B along the longer dimensional direction thereof (step S26). In particular, when any one reduced image Pr is specified among the plurality of reduced images Pr displayed in the display screen 7a on the basis of a predetermined operation performed by a user on the operation input unit 2, the display control unit 8f highlights the edge sections of the image display region A corresponding to the specified reduced image Pr (see FIG. 4) and scroll displays the letter string of the relating information D in the non-arranging region B of the image display region A along the longitudinal direction thereof (see FIGS. 5A to 5C).

At this time, the display control unit 8f scroll displays the letter string of the relating information D at the speed calculated by the speed calculation unit 8e in step S21.

Next, the CPU of the central control unit 1 determines whether an instruction to end the image display processing is input on the basis of a predetermined operation performed by a user on the operation input unit 2 (step S27).

When it is determined that the ending instruction is not input in step S27 (step S27; NO), the display control unit 8 returns the processing to step S25 and sequentially executes the processing thereafter.

On the other hand, when it is determined that the ending instruction is input in step S27 (step S27; YES), the CPU of the central control unit 1 ends the image display processing of the display control unit 8.

As described above, according to the image display apparatus 100 of the embodiment, in each of the plurality of image display regions A, the position for arranging the corresponding image P (reduced image Pr) is decided at least on the basis of either of the setting direction of the image pickup device when the image P was picked up and the ratio of the numbers of pixels in two directions which are orthogonal to each other in the image P. Therefore, the size of the corresponding reduced image Pr of the image P can be set so as to be displayed in a large size in the image display region A by taking the ratio of the numbers of pixels in the two direction of the image P which are orthogonal to each other into consideration. At the same time, the margin region (non-arranging region B) in the image display region A can be surely set in its maximum size on one side of the reduced image Pr by taking the setting direction of the image pickup device when the image P was picked up into consideration. Especially, by deciding the position for arranging the corresponding reduced image Pr so as to be against one of the two sides in the direction orthogonal to the setting direction of the image pickup device at the time the reduced image Pr (image p) was picked up in each of the approximately square shaped image display regions A, the non-arranging region B can be larger.

Moreover, in each of the image display regions A in which the position for arranging the corresponding image Pr is decided, the relating information D corresponding to the reduced image Pr (image P) is displayed in the non-arranging region B in the image display region A where the corresponding image Pr is not arranged along the longer dimensional direction thereof. Therefore, the relating information D can be displayed in the non-arranging region B, which is set by having its maximum size on one side of the reduced image Pr displayed in the image display region A, allowing the relating information D to be visually recognizes easily without switching to individual displaying of each image P. At this time, by scroll displaying the relating information D along the longer dimensional direction in the non-arranging region B, the display size of the relating information D can be large because a predetermined number of letters are to be displayed in the non-arranging region B at one time even when the length of the letter string constituting the relating information D in the longer dimensional direction is longer than the length of the non-arranging region B in the longer dimensional direction. Further, by setting the number of pixels in the shorter dimensional direction of the non-arranging region B as a reference, the display size of the relating information D to be displayed in the non-arranging region B can be calculated appropriately and the relating information D can be displayed in the non-arranging region B in the calculated display size.

Therefore, various types of relating information D corresponding to the images P can be displayed in a manner that can be visually recognized easily by effectively using the limited display region without impairing the characteristics of catalog display of the plurality of reduced images Pr displayed in one display screen 7a of the display unit 7.

Moreover, the number of reduced images Pr to be displayed in the display screen 7a at one time is arbitrarily specified and the image display regions A can be set in the display screen 7a according to the specified number of reduced images Pr. Therefore, catalog displaying style of the plurality of reduced images Pr can be changed according to the style which a user desires.

Further, the plurality of images P subjected to be displayed in the display screen 7a are arbitrarily specified and the plurality of images P are obtained as subjects to be processed. Therefore, the reduced images Pr corresponding to the plurality of images P which are desired by a user can be displayed in the display screen 7a.

Further, the speed for scroll displaying the letter string is calculated on the basis of the number of letters in the letter string corresponding to the relating information D and the letter string is scroll displayed at the calculated speed. Therefore, by setting the speed for scroll displaying so as to be relatively slow when the letter string is relatively short, the letter string can be visually recognized easier by a user. On the other hand, by setting the speed for scroll displaying so as to be relatively fast when the letter string is relatively long, the letter string can be scroll displayed in a short amount of time.

Moreover, when the relating information D includes image processing information relating to the content of image processing to be performed on the image P corresponding to the relating information D, by displaying the relating information D in the display style corresponding to the content of image processing, the content of image processing which is performed on the image P corresponding to the relating information D can be recognized by a user just by looking at the relating information D.

Similarly, by displaying the background region of the relating information D in the non-arranging region B of the image display region A in the display style corresponding to the content of image processing, the content of image processing which is performed on the image P which is the original image of the reduced image Pr displayed in the image display region A can be recognized by a user only by looking at the background region.

In the above embodiment, it is described that a plurality of images such as thumbnail images are displayed in the display region provided in the display unit in catalog format by being arranged in a predetermined lines and columns. However, the present invention is not limited to the above embodiment, and display can be such that one image is displayed in the display region.

Moreover, the present invention can be modified in various ways and the design can be changed within the scope of the invention.

For example, in the above embodiment, the number specifying unit 6a and the image specifying unit 6b are not necessarily required, and inclusion or non-inclusion of the number specifying unit 6a and the image specifying unit 6b can be decided arbitrarily. That is, the number of reduced images Pr to be displayed in the display screen 7a in a catalog format and the plurality of reduced images Pr which are subjected to be displayed can be preset as default.

Further, in the above embodiment, predetermined images P which are subjected to be displayed are obtained from the recording medium M. However, this is only an example and the obtaining method of predetermined images P can be changed arbitrarily. That is, for example, in a state where the image display apparatus 100 and an external information communication device are connected so as to perform information communication through a predetermined communication circuit, image data of predetermined images P sent from the information communication device can be received and obtained in the image display apparatus 100.

The configuration of the image display apparatus 100 is not limited to the example described in the above embodiment and can be modified arbitrarily.

As for a control device, the display control unit 8 which controls the display unit 7 is exemplified. However, control device is not limited to this. For example, any control device can be used as long as the control device is a control device which is connected with a display device (not shown in the drawing) which displays images P (reduced images Pr) so as to perform information communication and which can display the images P and relating information D corresponding to the images P in the display device by outputting data of the images P and the relating information D to the display device or is a control device which projects data of the images P and the relating information D corresponding to the images P onto a screen or a wall (not shown in the drawing) to display the images P and the relating information D.

Moreover, in the above embodiment, displaying of images is realized by the image obtaining unit 8a, the region setting unit 8b, the positioning unit 8c and the display control unit 8f of the display control unit 8 being driven under the control of the central control unit 1. However, the configuration is not limited to such configuration, and displaying of images may be realized by a predetermined program and the like being executed by the CPU of the central control unit 1.

That is, for example, a program including an obtain processing routine, a setting processing routine, a deciding processing routine and a control processing routine may be stored in a program memory which stored programs, and the obtaining processing routine may make the CPU of the central control unit 1 function as an obtaining device which obtains at least one displaying image from a recording device. Further, the setting processing routine may make the CPU of the central control unit 1 function as a setting device which sets at least one image display region A for displaying the displaying image and relating information corresponding to the displaying image. Furthermore, the deciding processing routine may make the CPU of the central control unit 1 function as a deciding device which decides the position for arranging the displaying image in the image display region A on the basis of the ratio of the numbers of pixels in the two direction of the displaying image which are orthogonal to each other. Further, the control processing routine may make the CPU of the central control unit 1 function as a display device which displays the relating information D corresponding to the displaying image in the non-arranging region B along the longer dimensional direction thereof, wherein the non-arranging region B is a region where the displaying image is not arranged in the image display region A in which the position for arranging the displaying image is decided by the deciding device.

Similarly, as for the first calculation device, the first specifying device, the second specifying device and the second calculation device, their configurations may be such that their functions are realized by predetermined programs or the like being executed by the CPU of the central control unit 1.

Moreover, as for the computer readable medium in which a program for executing the above various processing is stored, non-volatile memories such as a flash memory, portable recording mediums such as a CD-ROM can be used other than a ROM and hard disk. Further, as for a medium for providing program data through a predetermined communication circuit, carrier wave can also be used.

What is claimed is:

1. An image display apparatus, comprising
a recording unit in which a plurality of images are recorded;
an obtaining unit which obtains at least one displaying image from the recording unit;
a display unit which displays the displaying image;
a setting unit which sets at least one image display region in the display unit wherein the displaying image and relating information corresponding to the displaying image are to be displayed in the image display region;
a deciding unit which decides a position for arranging the displaying image in the image display region on the basis of a ratio of the numbers of pixels in two directions orthogonal to each other in the displaying image; and
a control unit which displays the relating information corresponding to the displaying image in a non-arranging region along a longer dimensional direction thereof, the non-arranging region being a region where the displaying image is not arranged in the image display region in which the position for arranging the displaying image is decided by the deciding unit.

2. The image display apparatus according to claim 1, further comprising a second specifying unit which specifies at least one displaying image to be displayed in the image display region, wherein
the obtaining unit obtains the displaying image specified by the second specifying unit.

3. The image display apparatus according to claim 1, wherein the deciding unit decides the position for arranging the displaying image in the image display region so as to be against one side that is in a direction orthogonal to a setting direction of an image pickup device when picking up the displaying image.

4. The image display apparatus according to claim 1, further comprising a first calculation unit which calculates a display size of the relating information to be displaying in the non-arranging region on the basis of the number of pixels in a shorter dimensional direction orthogonal to a longer dimensional direction in the non-arranging region,
wherein
the control unit displays the relating information in the non-arranging region in the display size calculated by the first calculation unit.

5. The image display apparatus according to claim 4, wherein the control unit scroll displays the relating information in the non-arranging region along the longer dimensional direction.

6. The image display apparatus according to claim 5, further comprising a second calculation unit which calculates a speed for scroll displaying a letter string of the relating information on the basis of the number of letters in the letter string, wherein
the control unit scroll displays the letter string at the speed calculated by the second calculation unit.

7. The image display apparatus according to claim 1, wherein
the relating information includes image processing information relating to a content of image processing performed on an image corresponding to the relating information, and
the control unit displays the relating information in a display style corresponding to the content of image processing on the basis of the image processing information.

8. The image display apparatus according to claim 7, wherein the control unit displays a background region of the relating information in the non-arranging region in a display style corresponding to the content of image processing on the basis of the image processing information.

9. The image display apparatus according to claim 1, further comprising a first specifying unit which specifies the number of images to be displayed at one time in the display unit, wherein
the setting unit sets a predetermined number of image display regions in the display unit according to the number of images specified by the first specifying unit and reduces the displaying image to a size displayable in the image display region.

10. The image display apparatus according to claim 9, wherein the image display regions are square shaped regions.

11. The image display apparatus according to claim 10, wherein the numbers of pixels in two directions orthogonal to each other in each image display region are same as or greater than a larger number among the numbers of pixels in two directions orthogonal to each other in the displaying image which is reduced.

12. An image display method utilizing an image display apparatus comprising a recording unit in which a plurality of images are recorded and a display unit, the method comprising:
obtaining at least one displaying image from the recording unit;
setting at least one image display region in the display unit wherein the displaying image and relating information corresponding to the displaying image are to be displayed in the image display region;
deciding a position for arranging the displaying image in the image display region on the basis of a ratio of the numbers of pixels in two directions orthogonal to each other in the displaying image; and
displaying the relating information corresponding to the displaying image in a non-arranging region along a longer dimensional direction thereof, the non-arranging region being a region where the displaying image is not arranged in the image display region in which the position for arranging the displaying image is decided by the deciding.

13. A computer readable recording medium in which a program for making a computer of an image display apparatus function as:
an obtaining unit which obtains at least one displaying image from the recording unit;
a setting unit which sets at least one image display region in the display unit wherein the displaying image and relating information, corresponding to the displaying image are to be displayed in the image display region;
a deciding unit which decides a position for arranging the displaying image in the image display region on the basis of a ratio of the numbers of pixels in two directions orthogonal to each other in the displaying image; and
a control unit which displays the relating information corresponding to the displaying image in a non-arranging region along a longer dimensional direction thereof, the non-arranging region being a region where the displaying image is not arranged in the image display region in which the position for arranging the displaying image is decided by the deciding unit,
wherein
the computer of the image display apparatus comprises a recording unit in which a plurality of images are recorded and a display unit.
